(19) United States
(12) Patent Application Publication
(10) Pub. No.: US 2009/0278692 A1
(43) Pub. Date: Nov. 12, 2009

(54) RFID Encrypted Paper Book

(76) Inventor: Saif Abdullah ALZAABI, Edmonton (CA)

Correspondence Address: Saif Abdullah Alzaabi, 2566 Hanna Cres N.W., Edmonton, T6R 3P7, CA

(21) Appl. No.: 12/118,717

(22) Filed: May 11, 2008

(51) Int. Cl. G08B 13/14

(52) U.S. Cl. 340/572.8

(57) ABSTRACT

The present invention provides an improved form of scientific printed textbooks. The invention relates to tagging of pictures/photos/illustrations in regular printed paper-books using Radio-frequency Identification (RFID) chips/inlays, for the purpose of linking those pictures/photos/illustrations to various remotely stored multimedia presentations. With the aid of a Bluetooth integrated RFID scanner, each RFID tag embedded in a particular picture/photograph/picture/illustration in this book can be decoded individually. The retrieved code (bunch of serial digits functioning as a unique electronic fingerprint) gets automatically transmitted wirelessly through the RFID scanner to a Bluetooth enabled viewing electronic device. The received code is then utilized by a specially developed software application (pre-installed on the viewing device) to instantaneously launch a case-specific multimedia (audio-video) presentation relates to that particular photograph/picture/illustration.

### BACKGROUND OF THE INVENTION

In the past decade, few attempts were made to develop purely digital electronic books (eBook) with hopes to replace the traditional paper-books, as the beginning of paperless era. Another reason for switching to eBooks is to simplify life of readers by providing much more readily accessible, storable and retrievable data.

Typical eBooks of this type are shown, for example, in the following United States of America patents:
U.S. Pat. No. 5,991,594 Froeber/Kim
U.S. Pat. No. 5,339,091 Yamazaki/Hamatani
U.S. Pat. No. 5,413,486 Burrows/Morris
U.S. Pat. No. 5,847,698 Reavey
U.S. Pat. No. 5,914,706 Kono
   Although, such eBooks have achieved some popularity and commercial success at time, for reasons discussed below there has been a continuing need for improvement.

The current trends show that production and sale of paper-books is continuously increasing. Up to date, millions or even billions of students (at all levels) worldwide walk daily to their respective schools carrying tons of printed books. There are many reasons for the ongoing resistance to the current eBooks. They are more vulnerable to piracy, data loss, and physical damage. eBooks are also more expensive to purchase and maintain. Similarly, number of reasons for the persisting reader's adherence to traditional printed books does exist. First and foremost, printed book format remains much cheaper with easily transferable ownership. Most readers prefer to read paper books, rather than depending solely on digitally scanned books. Although it is probably a minor issue for some, great number of readers enjoys the unique touch, smell, and texture of the paper-books. The above clearly exhibits that, it is to the interest of authors, publishers and even readers to preserve the paper-book entity without going completely digital.Additionally, it is crucial for both authors and to protect their intellectual properties and revenues by minimizing the vulnerability to the rising piracy of electronic data.

In attempts to combine almost all the advantageous features of both the eBooks and printed textbooks described above, we introduce the “RFID encrypted paper-book” innovation. This is a standard printed paper textbook, with a unique added feature of micro memory chips invisibly embedded in its paper substrate. The main idea is based on utilizing the Radio-frequency Identification (RFID) technology to wirelessly link pictures in printed material to remotely accessible multimedia presentations that are viewable on Bluetooth integrated electronic devices. RFID is emerging and well established technology. The RFID chips/inlays contain few lines of digital memory in the form of smart electronic code that is extremely accurate (error incidence is only 1/1,000,000).

### SUMMARY OF THE INVENTION

I, Saif Alzaabi, have invented an “RFID encrypted paper-book” as set forth in the following specification. The claimed book features photographs/pictures/illustrations physically encrypted with RFID micro-chips for the purpose of wirelessly link them to specific electronically viewable audio-video material.

In the drawings, which form a part of this specification;

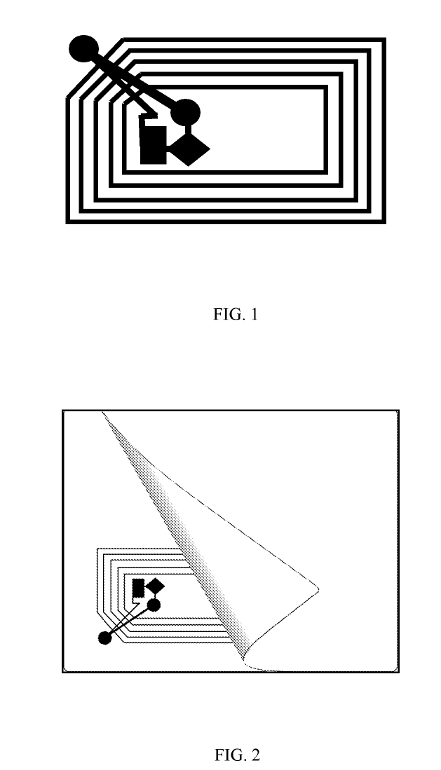

FIG. 1—illustrates one of many commercially available RFID chips or tags. These are marketed in various sizes, material, frequency, and memory capacity. In the example shown; Substrate: PET or Polyethylene-therephtalate, ultra-thin (0.35 mm thick) high frequency (13.56 MHz) transponder Inlays with 256 Bit memory is demonstrated. The center of the chip has an Aluminum antenna that helps any compatible scanner/reader to read the RFID tag remotely.

FIG. 2—illustrates an example of RFID chip embedded within paper substrate.

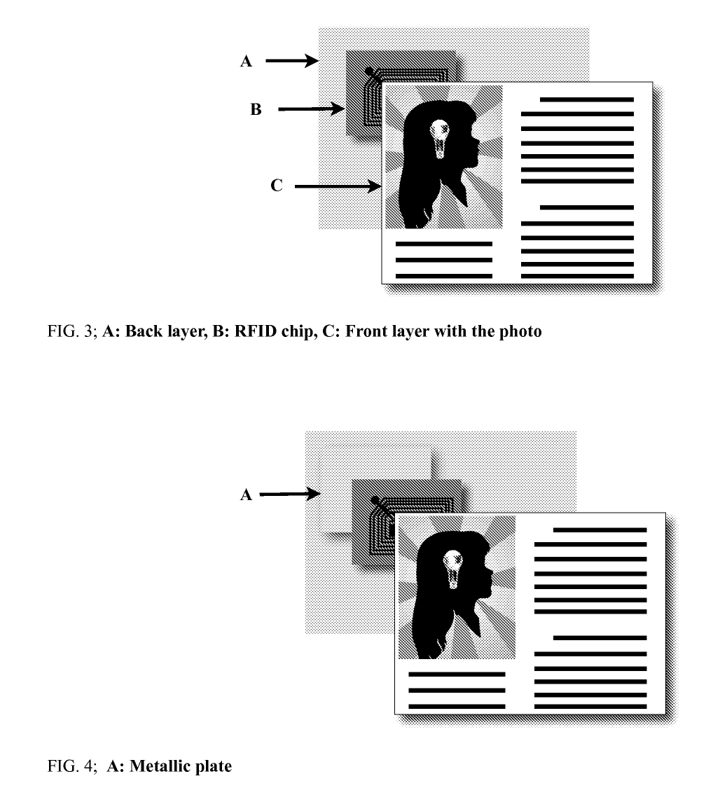

FIG. 3—illustrates placement of pre-programmed RFID chip immediately behind ta photograph. The RFID chip gives a unique code/tag (serial number) to this particular respective photograph/picture/illustration in the book that cannot be mimicked by any other photograph in the book.

FIG. 4—illustrates placement of the protective metallic micro-plate immediately behind the RFID chip in order to prevent unwanted scanning of the RFID chips embedded within the phonographs/pictures/illustrations in the underlying pages. This is fundamentally based on the fact that reading the RFID tag through paper or plastic material is possible, but not through metal. It is also important to note that the need for the protective micro-chip here is optional and may not be required when the RFID chips used are anti-collision or a unidirectional read type. Furthermore, placing the RFID chips in a non-overlapping manner in the book pages will omit the need for the protective layer. (Note: perfectly overlapped RFID tags cancel the read-out signal upon scanning with the RFID reader)

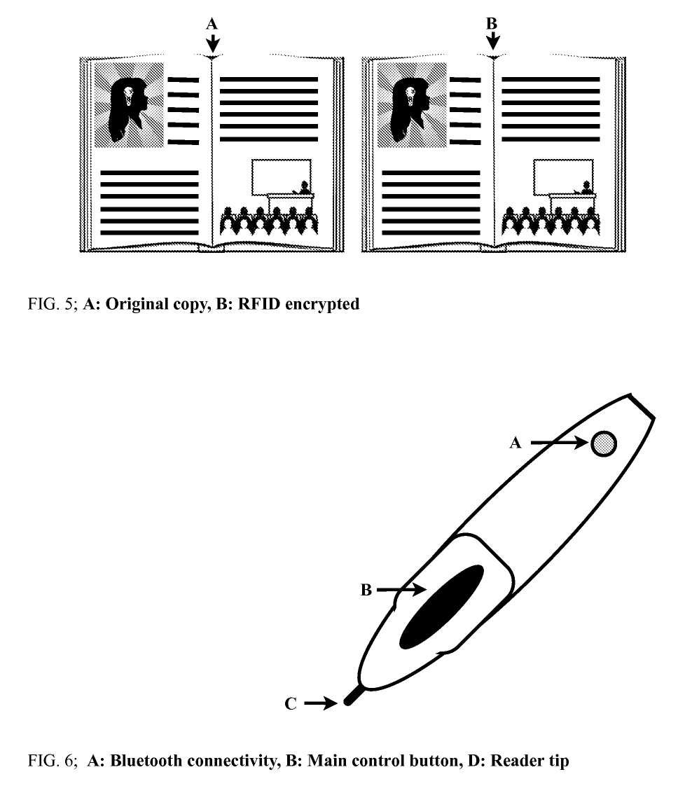

FIG. 5—illustrates that the original physical characteristics of the book are essentially preserved as both the RFID chips are seamlessly hidden within the paper substrate. As such the new RFID encrypted edition can hardly be distinguished from the original textbook.

FIG. 6—illustrates an example of commercially available Bluetooth RFID reader (scanner), high-lighting the scanning tip, the main control button as well as Bluetooth connectivity features.

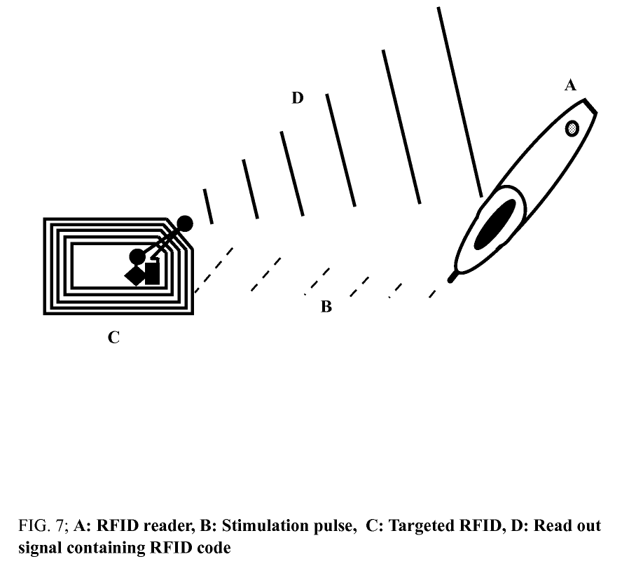

FIG. 7—illustrates the basic contact-less interaction between the RFID reader and the RFID chip. Upon pushing the main control button on the reader, an activation signal stimulates the RFID chip antenna. The stimulated antenna responds immediately by sending off a short-range (0-4 cm in this case) radio-frequency signal containing the encrypted code.

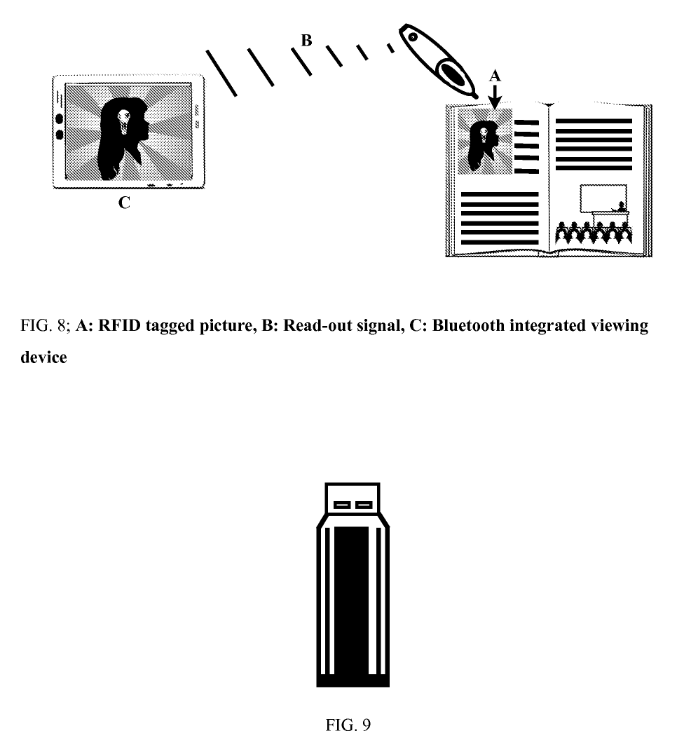

FIG. 8—illustrates how the RFID reader remotely detects the code (reading time is typically 100 milliseconds) and sends it automatically to the surrounding, where it gets picked up wirelessly by any available Bluetooth integrated device in the range. With the aid of specially designed software application, the received code is then utilized to launch a specific pre-stored multimedia (audio-video) material.

FIG. 9—illustrates a standard USB memory stick containing the RFID reader-viewing device interface application, the pre-made audio-video material, and the software program needed to run them. This is an optional feature, which provides easily portable software and multimedia material.

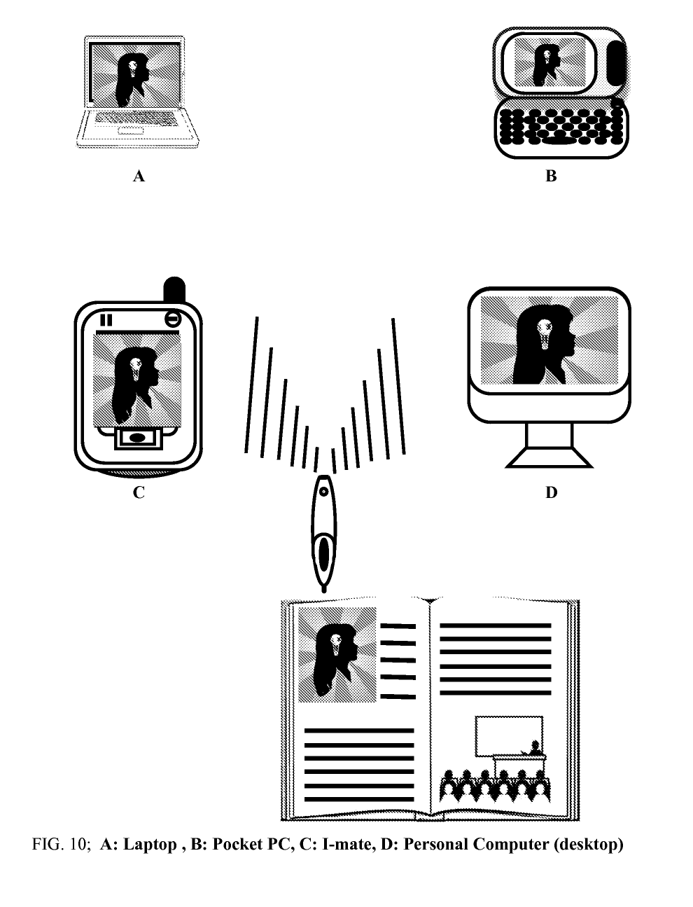

FIG. 10—illustrates the wide range of potential viewing devices that can be used to view the relevant multimedia on-demand.

### DETAILED DESCRIPTION OF THE INVENTION

The following is detailed description of the principle and methodology on the basis of which the “RFID encrypted paper-book” works. This sequentially describes the use of seamlessly embedded RFID micro-chips within the paper substrate of a scientific textbook for the purpose of wirelessly linking textbook's individual photos/pictures/illustrations with relevant and case-specific explanatory multimedia presentations, available on demand.

Standard commercially available ultra-thin (flat) RFID chip [FIG. 1] is initially embedded within the paper layers of a photo/picture/illustration in a regular textbook [FIGS. 2 and 3].

A thinner metallic micro-plate is placed behind the RFID tag, which is embedded along with the chip within the desired photograph/picture/illustration [FIG. 4]. The purpose of this specially designed plate is to shield the radio-frequency signal, so that each encrypted RFID code is read selectively one at a time. This would prevent unwanted stimulation of other RFID chips embedded within the underlying pages. This, however, may not be required if unidirectional (read only from one side) anti-collision (reading is not affected by other RFID chips that are present in the scanning range) RFID tags are used or if the RFID chips are placed in the pages in a non-overlapping manner.

Both the RFID tag and the protective metallic plate are invisible to the user; as they are seamlessly hidden within the paper material, so that the final product is a regular appearing textbook. In other words, the photos of the original copy cannot be distinguished from the new ones containing the RFID chips. [FIG. 5]. The RFID tags can be seen if the tagged photograph/picture/illustration if it is subjected to a bright light directed to the backside of the paper.

Commercially available Bluetooth RFID reader [FIG. 6] is used to retrieve individual code upon demand by placing the scanner tip in close proximity to that code.

Pushing the main button on the reader will trigger a reading pulse that in-turn stimulates the encrypted RFID memory in the RFID chip. Following its excitation, the RFID chip responds by sending off a radio-frequency signal in the form of a digital code or serial number [FIG. 7].

The RFID reader instantaneously transmits this code wirelessly to a Bluetooth integrated viewing device placed in the reading range. With the aid of pre-installed software application, this code gets converted into an executable command that will automatically launch a specific pre-stored multimedia (audio-video) presentation. [FIG. 8] The core purpose of this wirelessly linked multimedia is to further explain and elaborate on the tagged photograph/ picture/illustration and its relevant text.

The viewing device has to contain 3 fundamental components:
I. Interface software capable of synchronizing the RFID reader with the viewing device in order to recognize the transmitted code encryption.
II. Specially developed software application. This primarily designed to convert each wirelessly retrieved code into an executable command that would eventually launch the desired/relevant audio-video presentation.
IlI. Pre-made audio-video material that is stored on either internal or external memory. The multi-media presentation can take any form of such as; automated power point presentation, procedure demonstration video, recorded lecture, etc. . . . )
   As an added option; I,II, and III can be collectively integrated in a USB memory stick for the purpose of easy and flexible data transfer [FIG. 9]

The final end product works as follow: each time an individual RFID chip hidden under specific photograph/picture/illustration get read or scanned with Bluetooth RFID reader, the encrypted code is then channeled to run as specific pre-made, pre-stored audio-video presentation (as far as all above steps/requirements are met). The viewing device is defined as any Bluetooth integrated digital device that is capable of operating the interface software application and can launch the pre-stored specified multi-media. [FIG. 10] This can take many forms; such as Personal computer, laptop, Pocket PC, Cellular Phone, etc. . . .

Scanning another RFID encrypted photograph/picture/illustration in the book will over-ride the current played multimedia presentation. As such, the running presentation will get instantaneously terminated and replaced by the newly activated/requested one.

Volume adjustment, fast forwarding and back warding as will as pause function can be controlled from the viewing device itself. Alternatively, the RFID reader can be improved at a later stage to comprise them all if desired.

The embodiments of the invention in which an exclusive property or privilege is claimed are defined as follows:

1- A paper-book that contains photographs/pictures/illustrations tagged with Radio-frequency identification (RFID) chips.

2- An RFID encrypted paper-book in accordance to claim 1, wherein the RFID chips that can be used for tagging—as commercially available—include a wide range of different sizes, weights, shapes and operational frequency. The one chosen for the described book comprise—but not limited to—flat-thin 13.56 MHz compatible with the 13.56 RFID readers.

3- An RFID encrypted paper-book in accordance to claim 1, wherein the case-specific RFID tags are seamlessly embedded within the paper substrate behind all or selected photographs/pictures/illustrations in this book.

4- An RFID encrypted paper-book in accordance to claim 1, wherein the RFID tagged photographs/pictures/illustrations can be read with the aid of Bluetooth RFID reader.

5- An RFID encrypted paper-book in accordance to claim 1, wherein the RFID reader is compatible with (i.e. can fully read) the chosen RFID chips.

6- An RFID encrypted paper-book in accordance to claim 1, wherein the retrieved code from a photograph/picture/illustration (serial number or a bunch of digits) get wirelessly transmitted via the RFID reader to a Bluetooth integrated devices (such as—but not limited to—Personal Computer, Laptop, Pocket PC, tablet computer, or cellphone, etc. . . . )

7- An RFID encrypted paper-book in accordance to claim 1, wherein the pre-stored pre-recorded multi-media presentations (Examples—but not limited to—AVI, MPEG, ASF, Divx, WMV, or Real Media) can automatically and instantaneously be run with the aid of a specially written computer interface/software program on a Bluetooth integrated device as described in claim 6.

8- An RFID encrypted paper-book in accordance to claim 1, application of which is not limited to scientific textbooks, but also extends to include any other form of printed artwork containing photographs/pictures/or illustrations that require and/or will benefit from additional multimedia elaboration (operated and viewed using the same principal mechanism described in this invention)
